(19) United States
(12) Patent Application Publication
(10) Pub. No.: US 2006/0189235 A1
(43) Pub. Date: Aug. 24, 2006

(54) Reinforcement for building components and membranes, in particular roofing membranes

(76) Inventor: Taieb Marzouki, Thedinghausen (DE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/356,996

(22) Filed: Feb. 17, 2006

(30) Foreign Application Priority Data
Feb. 18, 2005 (DE) 102005007758.7
Mar. 1, 2005 (DE) 102005009345.0

(51) Int. Cl. B32B 5/02

(52) U.S. Cl. 442/59

(57) ABSTRACT

A reinforcement formed from filaments or fibers which have a core made of inorganic material and an outer sheathing of the core which is composed of organic material. The resulting reinforcement, in particular a roofing membrane with at least one support insert made from such a reinforcement, exhibits superior and balanced material characteristics.

### BACKGROUND OF THE INVENTION

1. Technical Field

The invention relates to a reinforcement pursuant to the preamble of claim 1, an application of the reinforcement and a roofing membrane having at least one covering layer and at least one support insert.

2. Prior Art

Reinforcements of the type discussed here are used for strengthening many kinds of building components, for example components used in the construction of vehicles, in plant construction and in the furniture industry. In addition, such reinforcements are also employed to form support or reinforcement inserts in various types of membranes and sheeting, above all those employed in the construction industry for building construction, civil engineering works and bridge building. A preferred application of these reinforcements is found in the field of building sealants, here primarily in the form of strip-like roofing membranes. Such reinforcements fall into two main categories, specifically those comprising inorganic fibers, filaments and the like, and those made of organic fibers, filaments and the like. Inorganic fibers are used to form glass fiber nonwovens, glass fiber wovens, or glass fiber nets, for example. Organic fibers are used to form, for example, polyester nonwovens, polyester wovens or polyester nets.

Inorganic fiber, such as glass fiber or even carbon fiber, exhibits low expansibility and thus has poor mechanical properties. In contrast, fiber made from inorganic material is cheap, fireproof and easy to process. Fiber made from organic materials, in particular plastics, has low dimensional stability, is expensive, flammable and more difficult to process. The advantages offered by organic plastic fiber are good expansibility and superior mechanical properties.

In order to reduce the disadvantages of the individual materials, it is known that reinforcements can be formed from composite layers of nonwovens, wovens and/or nets of inorganic and organic material. Such composite, multi-layer reinforcements are expensive and overcome the disadvantages posed by the individual materials only to a limited extent.

### BRIEF SUMMARY OF THE INVENTION

The invention is based on the object of providing a reinforcement and related applications, in particular a roofing membrane, which combine in a simple manner the advantages of inorganic and organic materials but which, at least to a large extent, lack the disadvantages of these individual materials.

A reinforcement for meeting this object is a reinforcement with bonded fibers of inorganic material, characterized in that the inorganic fibers have a covering of organic material. By providing the inorganic fibers, filaments, strands or the like with a covering of organic material, one obtains a kind of sandwich fiber comprising an inner core of stable, fire-proof inorganic material, such as glass, and an exterior of organic material with superior mechanical properties. In particular due to their outer covering of organic material, such composite fibers can be easily interconnected, intertwined and/or interweaved.

In a preferred embodiment of the reinforcement, the gauge or wall thickness of the organic covering is, at least in the case of nonwovens and wovens, less than the thickness, in particular the diameter, of the inorganic fibers, filaments or strands. Preferably the thickness of the covering is no more than 80%, in particular only 30% to 50%, of the diameter of the inorganic fibers, strands or filaments. As a result, the organic covering is provided with a mass or weight which corresponds approximately to that of polyester filaments or strands. The mass or weight of the organic covering can, however, be greater or less than the mass or weight of a polyester filament or strand.

The thickness of the covering for fibers used to form a nonwoven or woven reinforcement can be up to 0.01 mm. But in fibers used to form woven reinforcements, the core of inorganic filaments can in general have a somewhat greater diameter than those used in nonwoven reinforcements in that their covering has a gauge or wall thickness of up to 0.05 mm. For net-like reinforcements, the wall thickness or gauge of the covering can be even greater, namely up to 1 mm.

In relation to the grammage of the inorganic filaments and fibers, the grammage of the organic plastic covering or sheathing is 2 to 4 times greater. It has been demonstrated that this yields a material mix with markedly balanced characteristics, in particular with the greatest possible elimination of the disadvantages posed by the individual materials.

Suitable materials for the covering are preferably thermoplastic resins. These may be polyesters, but can also include polyamides, polypropylenes, polyethylene and other comparable thermoplastic resins. These plastics are economical and eliminate at least to a large extent the disadvantageous properties of inorganic fibers.

In a preferred reinforcement, the covering is formed by a closed outer sheathing of the inorganic fibers or filaments. Here the sheathing exhibits the thickness of the covering, thus measuring between approximately 0.005 mm and 1 mm, depending on whether the reinforcement is a nonwoven, woven or net.

The invention also provides that the individual filaments, fibers or strands of the reinforcement are connected to one another in the region of the covering or sheathing of organic material. This connection can be made by means of welding, sealing, adhesive bonding or the like, as well as a combination thereof. In a nonwoven reinforcement, the fibers, filaments or strands are connected to each other by thermal fortification, preferably by means of the outer organic sheathing or covering. Here the organic sheathing or covering lends itself to the good combinability of fibers, filaments or strands. In particular, the latter can be effectively and permanently connected by the outer sheathing of organic material which covers the inorganic fibers, strands or filaments. Thus, there is no need for additional bonding means for the thermal fortification.

The sheathed or covered inorganic fibers are connected such that the sheathing or covering of organic material, in particular thermoplastic resin, remains essentially intact in the areas of fiber connection. The sheathing or covering of organic material thus ensures a reliable cohesion of the fibers, strands or filaments.

Suitable materials for the inorganic fibers are preferably glass fiber, carbon fiber or the like. Inorganic filaments or strands can likewise be formed from glass or carbon.

According to the invention, the reinforcement described above is primarily employed to form at least portions of a support insert for building sealing materials, in particular for a roofing membrane. But the reinforcement according to the invention can also be used to form other types of material membranes, in particular sheet covering, and structural components used in the furniture and automotive industry. Likewise, the reinforcement according to the invention can be employed in the fields of plant construction, aircraft construction and shipbuilding. In these last-named fields, the reinforcement according to the invention is primarily employed to form fiberglass reinforced plastics.

### DETAILED DESCRIPTION OF PREFERRED EMBODIMENTS

A roofing membrane which fulfills the object stated at the beginning is a roofing membrane having at least one covering layer and at least one support insert, characterized in that the at least one support insert is formed at least partially by a reinforcement with bonded fibers of inorganic material, characterized in that the inorganic fibers have a covering of organic material. Accordingly, at least one support insert of the roofing membrane is at least partially formed from a reinforcement which has inorganic fibers, strands or filaments that are provided with a sheathing or covering of an organic material. The support insert can be strips of nonwovens, wovens or nets, or a combination thereof. A roofing membrane thus formed exhibits good mechanical properties and superior dimensional stability. Above all, a roofing membrane of this type is hardly combustible. In addition, the reinforcement according to the invention makes it possible to form a heavy-duty roofing membrane with merely a single support insert. This single support insert exhibits, i.e. incorporates, the properties of two or more separate support inserts of known roofing membranes.

Preferably the support insert is completely impregnated with bitumen, but also plastic or elastomer, for the formation of the roofing membrane, with the bitumen or similar material serving as the basic material surrounding or encompassing the sheathing of organic material around the inorganic fibers. This ensures a good connection between the basic material of the roofing membrane and the support insert, which prevents delaminating and in particular provides the roofing membrane with good rolling characteristics.

It is furthermore provided that the weight percentage of the sheathing of organic material in the roofing membrane corresponds approximately to the weight, in particular to the grammage, of a support insert made exclusively of organic material such as polyester, for example. Preferably, the weight percentage of the sheathing of organic material lies in the range of 60% to 120% of the weight (grammage) of the portion of inorganic material in the support insert. The weight percentage of organic material in the overall weight of the sheathed fibers is preferably greater than 40%. By virtue of this arrangement, a support insert is created with exceptional characteristics which essentially lack in particular the disadvantages of fibers, filaments or strands of inorganic material.

In the following, examples for the reinforcement according to the invention will be described in more detail:

If the reinforcement is to be a strip of nonwoven material, the starting material employed is glass filaments or even filaments made from similar materials, such as carbon fiber. For the sake of simplicity, reference will only be made in the following to glass filaments, it being understood that the invention is not meant to be restricted as such. During or after the production of the glass filaments, it is coated with a thermoplastic resin, such as polyethylene terephthalate polyethylene (PETP). The coating is applied such that the glass fibers are provided with a closed outer sheathing of the thermoplastic resin, with the weight percentage of the plastic sheathing corresponding approximately to the weight (grammage) of a conventional plastic nonwoven. The glass filaments or fibers of the reinforcement have a diameter ranging from 0.01 mm to 0.02 mm. The sheathing of organic material, such as PETP, has a gauge or wall thickness in the range of 0.003 mm to 0.01 mm, it being possible for it to have a value that is 30% to 80% of the diameter of the glass fibers. The grammage of the core of glass fibers or filaments can be 3 to 120 g/m², preferably lying in the range between 4 and 60 g/m². The grammage of the organic plastic sheathing is between 5 to 360 g/m². Preferably this grammage lies in the range of 6 to 200 g/m². Proportionately, the grammage of the organic plastic sheathing is 2 to 4 times higher than the grammage of the glass filaments or fibers which form the core.

A nonwoven mat is now continuously formed from the glass filaments sheathed in plastic, for example PETP, polyester or the like, in that the sheathed glass filaments are thermally fortified. Thermal fortification can also be achieved by the additional use of binding agents. Instead of employing the thermal fortification process, it is also conceivable to interconnect the glass filaments sheathed in plastic to the nonwoven membrane by means of adhesive bonding, sealing and/or the like.

The resulting nonwoven mat can have a mass per unit area, namely a total grammage, of preferably 10 to 260 g/m². The total grammage of the reinforcement made from a nonwoven mat does not have to be any more than that of a conventional plastic nonwoven.

The nonwoven mat formed from glass fibers sheathed in plastic can be employed in plant construction, in the furniture industry, for coverings such as flooring, in aircraft construction, vehicle construction or in shipbuilding. But above all, the nonwoven mat can be employed in the building trade, primarily as sealants in buildings, in particular as strip-like roofing membranes which meet the highest technical standards, with the result that a single-layer roof covering can be formed with only one roofing membrane.

Reinforcements can also be made in the manner described above in which the plastic-sheathed glass fibers, glass filaments or glass strands are formed from a woven textile reinforcement. In such reinforcement wovens, the glass fibers or glass filaments have approximately the same diameter as glass nonwovens. However, the diameter of the glass filaments or fibers can be somewhat larger in reinforcement wovens, specifically up to double the thickness, i.e. up to 0.04 mm. The sheathing of thermoplastic resin then has a gauge (wall thickness) of up to 0.04 mm. The thickness of the thermoplastic sheathing is preferably approximately 40% to 80% of the diameter of the glass fibers or filaments forming the core. The grammages of the glass fibers or filaments and the thermoplastic sheathing can correspond to the grammages cited above for nonwovens. Such woven reinforcements are also suitable for all fields of application previously described.

Finally, the reinforcement can also comprise a net of glass fibers, glass filaments or glass strands that is sheathed in plastic. In this case, the glass filaments or strands usually have an even greater diameter than those in glass nonwovens or glass wovens. The glass filaments or strands in the reinforcement net can be up to 1 mm in diameter, preferably up to 0.7 mm. The plastic sheathing of the glass filaments or strands can have a wall thickness as large as the diameter of the glass filaments or strands. The wall thickness of the plastic sheathing is preferably smaller, namely not exceeding 80% of the diameter of the glass filaments or strands. The grammage of the organic material (glass filaments or glass strands) of the reinforcement net lies in the range of 5 to 120 g/m. The grammage of the sheathing formed by the thermoplastic resin (polyester, PETP or the like) can then have a range of 10 to 150 g/m². The reinforcement net is also suitable for all fields of application described above in connection with the nonwoven reinforcement.

A strip-like roofing membrane can have a single support insert made from the previously described reinforcements. This support insert is provided on both sides with a covering layer of bituminous material, such as polymeric bitumen, standard bitumen or modified bitumen, or also plastic, such as PVC or an elastomer, for example EPDM. Moreover, the support insert is completely impregnated by the bitumen, plastic or elastomer.

The support insert is formed from at least one of the reinforcements pursuant to the invention. For example, the support insert can be composed of a nonwoven which has thermally fortified fibers. The fibers are made of inorganic material. They are preferably glass fibers. These fibers of inorganic material, in particular glass fibers, but also carbon fibers, for example, are coated with a thermoplastic resin which forms an closed outer sheathing of the glass fibers. The plastic employed is preferably polyester, PETP or the like. But other thermoplastic resins are suitable in this regard.

The glass fibers sheathed in the thermoplastic resin are then bonded to a nonwoven mat by means of thermal fortification. The thermal fortification process occurs in the region of the thermoplastic, preferably polyester, sheathing of the glass fibers, specifically without the use of any additional binding agents.

As an alternative, the preferably single support insert of the roofing membrane can also be composed of the woven reinforcement or reinforcement net described above.

It is also conceivable to provide the roofing membrane with two support inserts, which are then preferably spaced apart from one another, thus creating a third closed layer of bitumen or other material appropriate for the formation of roofing membranes between the support inserts. The thickness of the intermediate layer of bituminous material or the like corresponds at least to the thickness of one support insert, preferably a multiple thereof. When more than one support insert is present, different types of inserts can be employed, in particular comprising a combination of nonwovens, wovens and/or nets.

The roofing membranes described above having at least one support insert made from the reinforcements pursuant to the invention are suitable for use in fields of application with highly demanding technical requirements. The roofing membranes here are thus highly durable roofing membranes which possess superior dimensional stability and good mechanical properties. Moreover, such a high-quality roofing membrane is easy to manufacture and is practically non-combustible.

What is Claimed is:

1. A reinforcement with bonded fibers of inorganic material, characterized in that the inorganic fibers have a covering of organic material.

2. The reinforcement according to claim 1, characterized in that the organic covering and the inorganic covering each have a thickness, and the thickness of the organic covering is smaller than the thickness of the inorganic fibers.

3. The reinforcement according to claim 1, characterized in that the organic covering and the inorganic covering each have a grammage, and the grammage of the organic covering is 2 to 4 times the grammage of the inorganic fibers.

4. The reinforcement according to claim 1, characterized in that the covered inorganic fibers are connected to one another in the region of their covering.

5. The reinforcement according to claim 4, characterized in that the covered inorganic fibers are thermally connected to each other in the region of their covering.

6. The reinforcement according to claim 4, characterized in that the covered inorganic fibers are formed into a nonwoven mat, and the covered inorganic fibers for forming the nonwoven mat are connected to each other by means of thermal fortification.

7. The reinforcement according to claim 6, characterized in that the covered inorganic fibers for forming the nonwoven mat are connected to each other by the thermal fortification of the organic covering.

8. The reinforcement according to claim 7, characterized in that the covered inorganic fibers are connected such that the covering of the inorganic fibers remains intact in the regions of connection.

9. The reinforcement according to claim 1, characterized in that the organic covering is composed of a thermoplastic resin.

10. The reinforcement according to claim 1, characterized in that the covering is configured as a closed outer sheathing of the inorganic fibers.

11. The reinforcement according to claim 1, characterized in that the inorganic fibers have a grammage, and the grammage of the inorganic fibers lies between 3 and 120 g/m².

12. The reinforcement according to claim 1, characterized in that the organic sheathing has a grammage, and the grammage of the organic sheathing corresponds to 5 to 360 g/m².

13. An application of a reinforcement according to claim 1 for the formation of at least portions of a support insert for a roofing membrane.

14. A roofing membrane having at least one covering layer and at least one support insert, characterized in that the at least one support insert is formed at least partially by a reinforcement pursuant to claim 1.

15. The roofing membrane according to claim 14, characterized in that the support insert is completely impregnated by material of the at least one covering layer, with the material of the at least one covering layer encompassing the organic-material sheathing of the inorganic fibers.

16. The roofing membrane according to claim 15, characterized in that the weight percentage of the organic-material sheathing is more than 40% of the weight of the entire support insert.
